(19) United States
(12) Patent Application Publication
(10) Pub. No.: US 2007/0025099 A1
(43) Pub. Date: Feb. 1, 2007

(54) Collection bowl illuminator

(76) Inventor: Garet K. Urban, Fort Lauderdale, FL (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/191,943

(22) Filed: Jul. 29, 2005

(51) Int. Cl. F21V 33/00

(52) U.S. Cl. 362/101; 362/96; 362/253; 362/396; 362/370

(57) ABSTRACT

A collection bowl illuminator including a reflector for positioning flush against the collection bowl of a fuel filter. The reflector has a semi-circular wall with opposed edges that are doubled back upon one another to define a forwardly opening concavity. The semi-circular wall also has opposed ends that are capped by end plates. A bracket is secured to the reflector for releasable attachment to a fuel filter adjacent its collection bowl. An electrical socket is secured within the concavity and can be connected to an electrical current source by a pair of electrical leads extending from it. A light bulb is positioned within the concavity and is connected to the electrical socket so as to receive an electrical current from the electrical current source and be illuminated thereby.

### FIELD OF THE INVENTION

The present invention relates generally to measuring and testing implements and, more particularly, to liquid level or depth gauges with illumination.

### BACKGROUND OF THE INVENTION

The U.S. Coast Guard requires that commercial vessels be supplied with fuel filters to improve air quality and reduce the likelihood of vessels stalling on waterways and blocking traffic. These filters remove contaminants like dirt, rust, algae, and water from fuel as it flows to an engine. Many of these filters incorporate a fuel heater to ensure that an engine starts easily in cold weather. Because the service lives of engines are lengthened considerably, no operator of a workboat, a fishing vessel, or a passenger ferry balks at installing a fuel filter. Today, fuel filters are ubiquitous on commercial vessels.

Two common brands of fuel filters are RACOR and DETROIT DIESEL. Both brands of filters act as centrifuges, spinning suspended solids and water droplets from fuel. Having a density greater than fuel, the spun contaminants settle to the bottom of the filter where they are gathered in a transparent collection bowl where they can be drained off through a manually operated valve. Failure to drain the contaminants can lead to their passage into an engine; so, periodic checks of the bowl and its contents must be performed.

It is not always easy for individuals working in the engine room of a vessel to see whether the collection bowl of a fuel filter contains any contaminants. A relatively dark working environment and minimally contrasting colors between contaminants and fuel usually necessitate the pressing of a flashlight against a collection bowl to illuminate the interior of the bowl to conduct an inspection. Since moving vessels tend to pitch and roll, an inspector can become injured with his hands being tied up manipulating a flashlight. A need, therefore, exists for a device that illuminates the collection bowls of commonly used fuel filters, permitting hands free inspections thereof.

### SUMMARY OF TH INVENTION

In light of the problems associated with known procedures and equipment used to inspect the collection bowls of fuel filters employed on commercial vessels, it is a principal object of the invention to provide an illuminator for the collection bowl of a fuel filter that permits a user to see the contents of the collection bowl from a distance, and in a hands-free manner, to determine whether contaminants are present and whether draining the bowl is needed.

It is another object of the invention to provide a collection bowl illuminator of the type described that can be used with RACOR, DETROIT DIESEL and other brands of fuel filters without modification to the filters. The illuminator can be quickly installed on a filter with minimal instruction and conventional tools at the time of initial assembly of the filter in a factory or as a retrofit in the field. With one embodiment of the invention, the threaded fasteners originally employed to secure the collection bowl to the remainder of the filter can also be used to hold the illuminator in place.

It is a further object of the invention to provide an illuminator of the type described that is energized by connecting such to the electrical system of the vessel within which it is installed. Thus, a user need not be concerned with the maintenance of a supplemental power source for servicing the illuminator alone.

It is an object of the invention to provide improved elements and arrangements thereof in a collection bowl illuminator for the purposes described that is lightweight in construction, inexpensive to manufacture, and dependable in use.

Briefly, the collection bowl illuminator in accordance with this invention achieves the intended objects by featuring a reflector for positioning against the collection bowl of a fuel filter. The reflector has a semi-circular wall with opposed edges that are doubled back upon one another to define a forwardly opening concavity. The semi-circular wall also has opposed ends that are capped by end plates. A bracket (two described in detail hereinbelow) is secured to the reflector for releasable attachment to a fuel filter adjacent its collection bowl. An electrical socket is secured within the concavity and can be connected to an electrical current source by a pair of electrical leads extending from it. A light bulb is positioned within the concavity and is connected to the electrical socket so as to receive an electrical current from the electrical current source and be illuminated thereby.

The foregoing and other objects, features and advantages of the present invention will become readily apparent upon further review of the following detailed description of the preferred embodiments as illustrated in the accompanying drawings.

### BRIEF DESCRIPTION OF THE DRAWINGS

The present invention may be more readily described with reference to the accompanying drawings, in which:

FIG. 1 is a perspective view of a collection bowl illuminator in accordance with the present invention.

FIG. 2 is a front view of the collection bowl illuminator of FIG. 1.

FIG. 3 is a bottom view of the collection bowl illuminator of FIG. 1.

FIG. 4 is a rear view of the collection bowl illuminator of FIG. 1.

FIG. 5 is a side view of the collection bowl illuminator of FIG. 1 shown mounted on a DETROIT DIESEL fuel filter adjacent the collection bowl thereof.

FIG. 6 is a perspective view of another collection bowl illuminator in accordance with the present invention.

FIG. 7 is a top view of the collection bowl illuminator of FIG. 6.

FIG. 8 is a front view of the collection bowl illuminator of FIG. 6.

FIG. 9 is a perspective view of the collection bowl illuminator of FIG. 6 shown mounted on a RACOR fuel filter adjacent the collection bowl thereof.

Similar reference characters denote corresponding features consistently throughout the accompanying drawings.

### DETAILED DESCRIPTION OF THE PREFERRED EMBODIMENTS

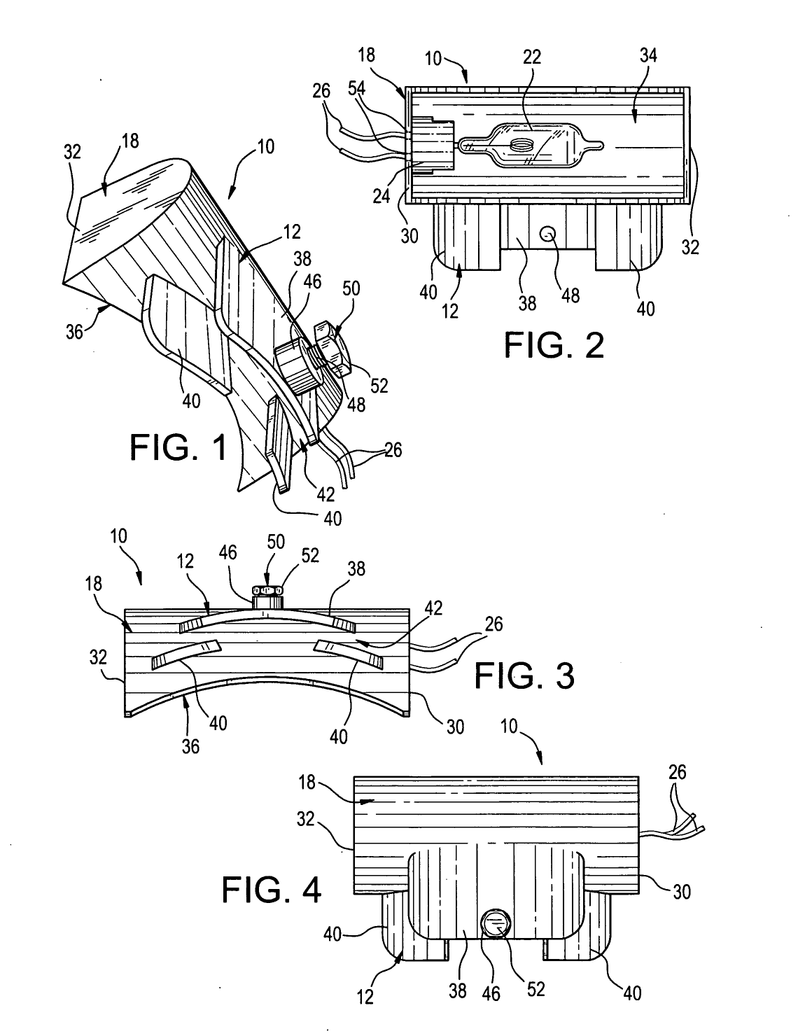

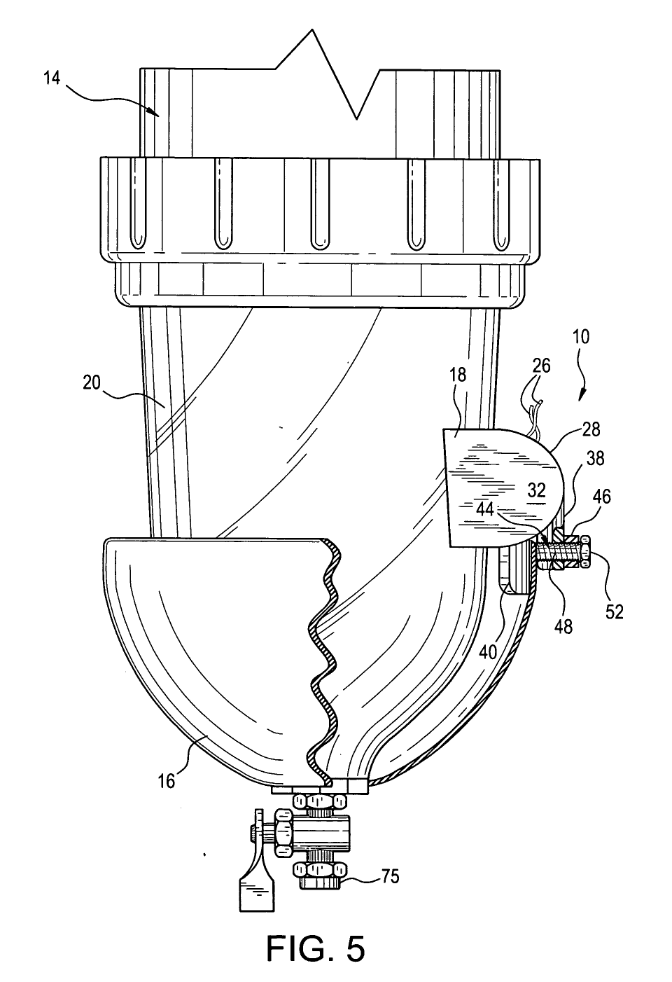

Referring to FIGS. 1-5, a collection bowl illuminator in accordance with the present invention is shown at 10. Illuminator 10 includes a bracket 12 for attachment to a DETROIT DIESEL fuel filter 14 at the top of the heat deflector shield 16 of filter 14. Extending upwardly from bracket 12 is a reflector 18 that opens toward the collection bowl 20 of filter 14. Positioned within reflector 18 is a light bulb 22 that is connected to an electrical current source by means of a socket 24 with conductive leads 26 extending therefrom.

Reflector 18 includes a semi-circular wall 28 that is capped at its opposite ends by a pair of end plates 30 and 32. Semi-circular wall 28 has a top edge and a bottom edge that are doubled back upon one another to define a concavity 34 that opens forwardly toward the front of illuminator 10 and has a size sufficient to accommodate both light bulb 22 and socket 24. A pair of rounded cutouts or recesses 36 is provided in the top and bottom ends of semi-circular wall 28 to ensure a snug fit of reflector 18 against collection bowl 20. Recesses 36 extend from end plate 30 to end plate 32.

Bracket 12 is attached to semi-circular wall 28. Bracket 12 has a clamping plate 38 that extends downwardly from the rear of reflector 18 and a pair of backing plates 40 that extend downwardly from the middle of reflector 18. A slot 42 is formed between clamping plate 38 and backing plates 40 for receiving the top of deflector shield 16. To ensure a snug fit against the curved form of deflector shield 16, slot 42 is similarly curved by making the front of clamping plate 38 concave and the rear of each backing plate 40 convex. To further ensure a snug fit, each backing plate 40 is positioned adjacent a respective one of the opposite ends of clamping plate 38 thus providing three widely spaced points of contact between bracket 12 and deflector shield 16 as will become apparent below.

An internally threaded bore 44 penetrates clamping plate 38 as well as a cylindrical boss 46 affixed to the rear of clamping plate 38 for reinforcement purposes. The shaft 48 of a threaded fastener 50 is threadably engaged with bore 44 and projects into slot 42. The head 52 of fastener 50 is positioned adjacent boss 46 rearward of clamping plate 38. By rotating head 52, shaft 48 is selectively extended into slot 42 to drive deflector shield 16 against both backing plates 40 thereby locking illuminator 10 upon filter 14.

Light bulb 22 can be any incandescent or fluorescent emitter of visible radiation. A Zenon-type bulb manufactured by GE and capable of producing 20 W of power at 120 VAC has been found suitable for use in illuminator 10. The GE bulb is ideal since it provides high-intensity light but produces little heat. Light bulb 22 can also be a light emitting diode (LED) in which case a socket 24 may not be required.

Socket 24 is of a type suitable to provide releasable support for, and electrical energy to, bulb 22. Attachment of socket 24 to end plate 30 within reflector 18 is accomplished by means of suitable adhesives or fastenings (not shown). If desired, socket 24 can be made removable from end plate 30 for easy repair or replacement in the event that such may become necessary over the life of illuminator 10.

A pair of electrical leads 26 extends laterally from socket 24 and through a pair of holes 54 provided in end plate 30 to connect socket 24 to an electrical current source. The usual current source on a large vessel is an electrical generator or storage battery. Should illuminator 10 be used in a facility on land, leads 26 can be connected to an electrical grid.

From the foregoing, it should be appreciated that use of illuminator 10 is straightforward. First, fastener 50 is loosened to fully open slot 42. Then, the top of deflector shield 16 is inserted into slot 42 with clamping plate 38 being positioned against the exterior of deflector shield 16 and backing plates 40 being positioned against the interior of deflector shield 16. Next, by tightening fastener 50, illuminator 10 is secured to filter 14. Once leads 26 are connected to an electrical current source, bulb 22 is illuminated. The contents of collection bowl 20 can now be seen at a great distance in a hands-free manner and without resort to a flashlight. Should water or other fuel contaminants be seen in bowl 20, such can be easily drained by temporarily opening the valve 75 provided for this purpose at the bottom of bowl 20. Inspections of bowl 20 are accomplished in a matter of seconds in complete safety.

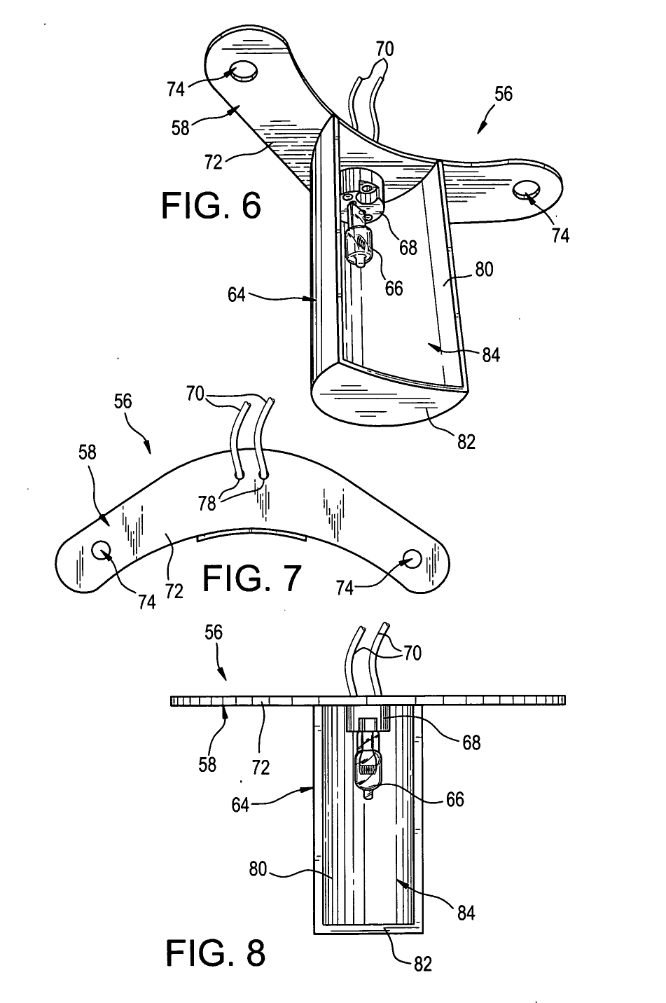

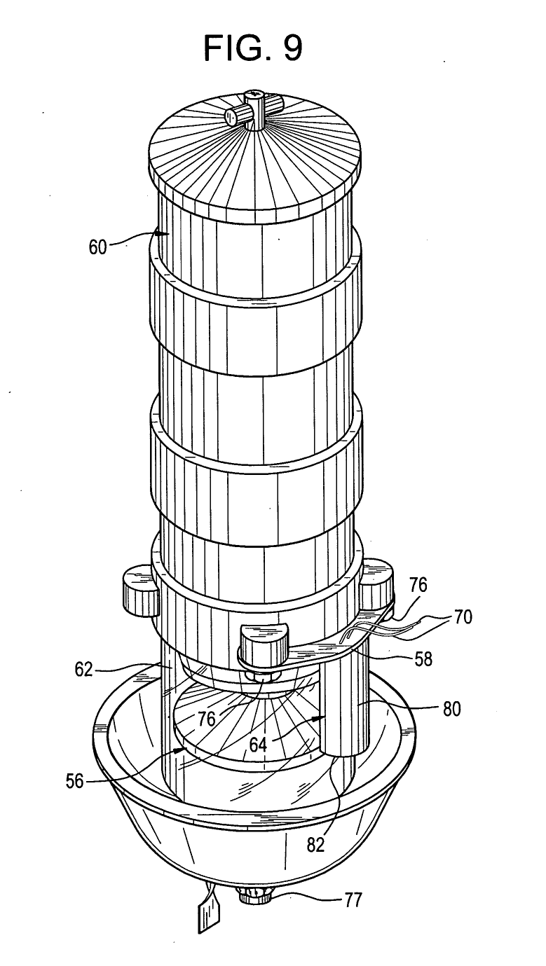

Referring now to FIGS. 6-9, an alternative collection bowl illuminator is shown at 56. Illuminator 56 includes a bracket 58 for attachment to a RACOR fuel filter 60 at the top of the transparent collection bowl 62 of filter 60. Extending downwardly from bracket 58 is a reflector 64 that opens toward bowl 62. Positioned within reflector 64 is a light bulb 66 that is connected to an electrical current source by means of a socket 68 with conductive leads 70 extending therefrom.

Bracket 58 comprises an end plate 72 having a U-shaped outline. The front of plate 72 is concave and has a radius of curvature that is the substantially the same as that of bowl 62 to assure a snug fit against bowl 62 when illuminator 56 is mounted on filter 60. Mounting is accomplished by means of a pair of apertures 74 respectively provided at the opposite ends of plate 72 for the passage of a pair of threaded fasteners 76. (In the absence of illuminator 56, fasteners 76 are employed to attach bowl 62 to the bottom of filter 60.) A pair of holes 78 is provided at the center of plate 72 for the passage of conductive leads 70.

Reflector 64 includes a semi-circular wall 80 that extends downwardly from the bottom of plate 72, encircling holes 78, and an end plate 82 affixed to the bottom of semi-circular wall 80. Semi-circular wall 80 has opposed edges that are doubled back upon one another to define a concavity 84 that opens forwardly toward the front of illuminator 10 and has a size that is sufficient to accommodate both socket 68 and light bulb 66. End plate 82, however, is substantially parallel to end plate 72 and its front is concave like end plate 72 for a snug fit against bowl 62.

Like light bulb 22, light bulb 66 can be any emitter of visible radiation including an LED. Preferably, bulb 66 produces minimal heat.

Socket 68 is of a type suitable to provide releasable support for, and electrical energy to, bulb 66. Attachment of socket 68 to the bottom of end plate 72 within reflector 64 is accomplished by means of suitable adhesives or fasteners (not shown). If desired, socket 68 can be made removable from end plate 72 for purposes of repair or replacement.

A pair of electrical leads 70 extends upwardly from socket 68 and through holes 78 in end plate 72 to connect socket 68 to an electrical current source.

Illuminator 56 is easy to use. First, fasteners 76 are unscrewed from filter 60. Next, end plate 72 is positioned against the top of collection bowl 62 such that apertures 74 are aligned with the openings in filter 60 from which fasteners 76 just came. Then, fasteners 76 are replaced thereby attaching illuminator 56 to filter 60. With reflector 64 now opening toward bowl 62, leads 70 are connected to an electrical current source to energize bulb 66 to illuminate the interior of bowl 62. The contents of bowl 62 can now be seen at a distance in a hands-free manner and without resort to a flashlight. Should water or other fuel contaminants be seen in bowl 62, such can be easily drained by temporarily opening the valve 77 at the bottom of bowl 62. Inspections of bowl 62 are accomplished in a matter of seconds in complete safety so that engines having filters equipped with illuminator 56 are kept waterproof, rustproof, and dirt proof.

While the invention has been described with a high degree of particularity, it will be appreciated by those skilled in the art that modifications may be made thereto. For example, the interior surfaces of reflectors 18 and 64 can be provided with reflective liners or coatings (neither shown) to maximize the luminosity of illuminators 10 and 56. Therefore, it is to be understood that the present invention is not limited to the several embodiments described above, but encompasses any and all embodiments within the scope of the following claims.

I claim:

1. A collection bowl illuminator, comprising:
a reflector for positioning flush against the collection bowl of a fuel filter, said reflector including a semi-circular wall having opposed edges being doubled back upon one another so as to define a forwardly opening concavity therebetween, and said semi-circular wall also having opposed ends, each of said opposed ends being capped by one of a pair of end plates,
a bracket being secured to said reflector for releasable attachment to a fuel filter one adjacent the collection bowl thereof;
an electrical socket being secured within said concavity of said reflector to one of said end plates and being adapted for connection to an electrical current source by means of a pair of electrical leads extending therefrom; and,
a light bulb being positioned within said concavity of said reflector and being connected to said electrical socket so as to receive an electrical current from the electrical current source and be illuminated thereby.

2. The illuminator of claim 1 wherein said bracket includes:
a clamping plate extending downwardly from said semi-circular wall;
a pair of spaced-apart backing plates extending downwardly from said semi-circular wall forwardly of said clamping plate so as to define a slot between said backing plates and said clamping plate for receiving a portion of the fuel filter; and,
a fastener being threadably engaged with said clamping plate, said fastener having a threaded shaft that can be selectively extended into said slot to engage the portion of the fuel filter received therein and having a head positioned rearward of said clamping plate for rotating said threaded shaft.

3. The illuminator of claim 1 wherein one of said end plates has opposite ends that extend outwardly from said semi-circular wall in a U-shaped configuration to partially encircle the collection bowl of a fuel filter and to define said bracket, each of said opposite ends being provided with an aperture for the passage of a threaded fastener for securing said illuminator to the fuel filter.

4. A collection bowl illuminator, comprising:
a reflector including a semi-circular wall having a top edge and a bottom edge being doubled back upon one another so as to define a forwardly opening concavity therebetween, and said semi-circular wall also having opposed ends, each of said opposed ends being capped by one of a pair of end plates, said top edge and said bottom edge each being provided with a recess extending from one of said opposed ends to the other of said opposed ends for a flush fit against the collection bowl of a fuel filter;
a bracket for attachment to the heat deflector shield of a fuel filter, said bracket including:
a clamping plate extending downwardly from said semi-circular wall;
a pair of spaced-apart backing plates extending downwardly from said semi-circular wall forwardly of said clamping plate so as to define a slot between said backing plates and said clamping plate for receiving the top of the deflector shield; and,
a fastener being threadably engaged with said clamping plate, said fastener having a threaded shaft that can be selectively extended into said slot to engage the deflector shield and having a head positioned rearward of said clamping plate for rotating said threaded shaft;
an electrical socket being secured within said concavity of said reflector to one of said end plates and being adapted for connection to an electrical current source by means of a pair of electrical leads; and,
a light bulb being positioned within said concavity of said reflector and being connected to said electrical socket so as to receive an electrical current from the electrical current source.

5. A collection bowl illuminator, comprising:
a reflector including a semi-circular wall having opposed edges being doubled back upon one another so as to define a forwardly opening concavity therebetween, and said semi-circular wall also having opposed ends, each of said opposed ends being capped by one of a pair of end plates, one of said end plates defining a bracket having opposite ends that extend outwardly from said semi-circular wall in a U-shaped configuration for partially encircling the collection bowl of a fuel filter, each of said opposite ends being provided with an aperture for the passage of a threaded fastener for securing said illuminator to a fuel filter;
an electrical socket being secured within said concavity of said reflector to said end plate having opposite ends that extend outwardly from said semi-circular wall and being adapted for connection to an electrical current source by means of a pair of electrical leads; and,
a light bulb being positioned within said concavity of said reflector and being connected to said electrical socket so as to receive an electrical current from the electrical current source.
